(19) United States
(12) Patent Application Publication
(10) Pub. No.: US 2004/0140419 A1
(43) Pub. Date: Jul. 22, 2004

(54) Image sensor with improved sensor effects

(76) Inventors: Jackson Hsieh, Hsinchu Hsien (TW); Jichen Wu, Hsinchu Hsien (TW); Bruce Chen, Hsinchu Hsien (TW); Kuo-Tai Tseng, Hsinchu Hsien (TW)

Correspondence Address: PRO-TECHTOR INTERNATIONAL, 20775 Norada Court, Saratoga, CA, 95070-3018, US

(21) Appl. No.: 10/346,766

(22) Filed: Jan. 16, 2003

(51) Int. Cl. H01J 40/14

(52) U.S. Cl. 250/214 R

(57) ABSTRACT

An image sensor with improved sensor effects includes a substrate, a frame layer, a photosensitive chip, wires, and a transparent layer. The substrate has an upper surface and a lower surface. Signal input terminals are formed at a periphery of the upper surface, and projections with the same height are formed at a central portion of the upper surface. The frame layer is arranged at a periphery of the substrate to form a U-shaped structure and a cavity together with the substrate. The signal input terminals and projections are inside the cavity. The photosensitive chip is arranged on the projections. The wires electrically connect the photosensitive chip to the signal input terminals of the substrate. The transparent layer is placed on the frame layer to cover the photosensitive chip. By placing the photosensitive chip on the projections, better flatness and thus better sensor effects may be obtained.

### BACKGROUND OF THE INVENTION

1. Field of the Invention

The invention relates to an image sensor with improved sensor effects, and in particular to an image sensor including a photosensitive chip that is flatly arranged so that its sensor effects become better.

2. Description of the Related Art

Referring to FIG. 1, a conventional image sensor includes a substrate 10, a frame layer 18, a photosensitive chip 26, wires 28, and a transparent layer 34. The substrate 10 has a first surface 12 on which signal input terminals 15 are formed, and a second surface 14 on which signal output terminals 16 are formed. The frame layer 18 has an upper surface 20 and a lower surface 22 adhered to first surface 12 of the substrate 10 to form a cavity 24 together with the substrate 10. The photosensitive chip 26 is arranged within the cavity 24 and is mounted to the first surface 12 of the substrate 10. Each wire 28 has a first terminal 30 and a second terminal 32. The first terminals 30 are electrically connected to the photosensitive chip 26, and the second terminals 32 are electrically connected to the signal input terminals 15 of the substrate 10. The transparent layer 34 is adhered to the upper surface 20 of the frame layer 18.

In the above-mentioned structure, when the first surface 12 of the substrate 10 is not flat or flat enough, the photosensitive chip 26 cannot be evenly mounted to the substrate 10 and the sensor effects of the photosensitive chip 26 are poor.

### SUMMARY OF THE INVENTION

An object of the invention is to provide an image sensor with improved sensor effects, wherein a photosensitive chip may be flatly mounted to a substrate.

To achieve the above-mentioned object, an image sensor of the invention includes a substrate, a frame layer, a photosensitive chip, wires, and a transparent layer. The substrate has an upper surface and a lower surface. Signal input terminals are formed at a periphery of the upper surface, and projections with the same height are formed at a central portion of the upper surface. The frame layer is arranged at a periphery of the substrate to form a U-shaped structure and a cavity together with the substrate. The signal input terminals and projections are inside the cavity. The photosensitive chip is arranged on the projections. The wires electrically connect the photosensitive chip to the signal input terminals of the substrate. The transparent layer is placed on the frame layer to cover the photosensitive chip.

By placing the photosensitive chip on the projections, better flatness and thus better sensor effects may be obtained.

### BRIEF DESCRIPTION OF THE DRAWINGS

FIG. 1 is a cross-sectional view showing a conventional image sensor.

FIG. 2 is a cross-sectional view showing an image sensor of the invention.

FIG. 3 is a first schematic illustration showing the image sensor of the invention.

FIG. 4 is a second schematic illustration showing the image sensor of the invention.

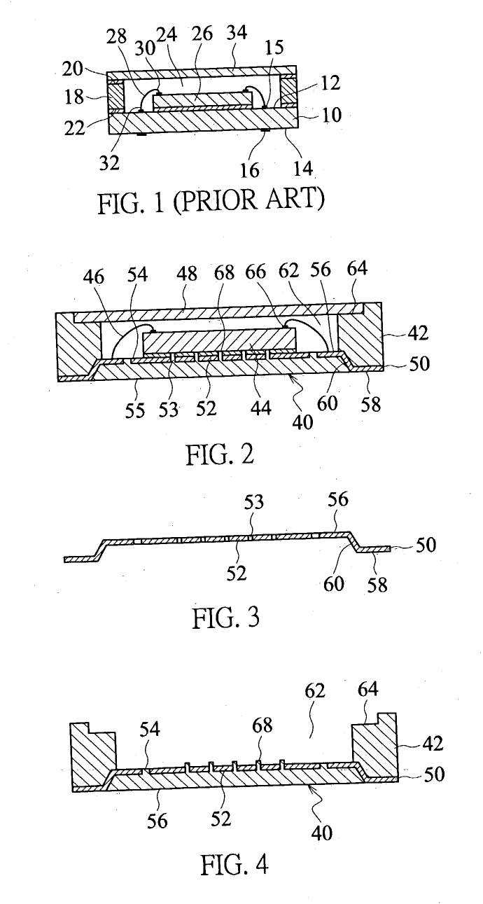

### DETAILED DESCRIPTION OF THE INVENTION

Referring to FIG. 2, an image sensor includes a substrate 40, a frame layer 42, a photosensitive chip 44, a plurality of wires 46 and a transparent layer 48.

In this embodiment, the substrate 40 is composed of a plurality of metal sheets 50 and a middle board 52. The middle board 52 is formed with a plurality of through holes 53. The metal sheets 50 and middle board 52 are surrounded and sealed by an injected material to form the substrate 40 having an upper surface 54 and a lower surface 55. Each metal sheet 50 includes a first board 56, a second board 58 and a third board 60. The first boards 56 are exposed from the upper surface 54 of the substrate 40 to form signal input terminals, and the second boards 58 are exposed from the lower surface 55 of the substrate 40 to form signal output terminals. In addition, the injected material is formed into projections 68 protruding from the upper surface 54 of the substrate through the through holes 53 of the middle board 52.

The frame layer 42 is combined with the substrate 40 by way of injection molding and is positioned at a periphery of the substrate 40. Therefore, the substrate 40 and the frame layer 42 form a U-shaped structure and a cavity 62. Meanwhile, the first boards 56 (signal input terminals) on the substrate 40 and the projections 68 are positioned within the cavity 62, and a flange 64 on an upper end of the frame layer 42.

The photosensitive chip 44 is formed with a plurality of bonding pads 66 and is arranged on the projections 68 formed on the upper surface 54 of the substrate 40. Consequently, as long as the projections 68 have the same height, the photosensitive chip 44 may be flatly fixed to the substrate 40. Even if the upper surface 54 of the substrate-40 is not flat enough, the photosensitive chip 44 may also be flatly positioned to obtain better sensor effects.

The wires 46 electrically connect the bonding pads 66 of the photosensitive chip 44 to the first boards 56 (signal input terminals) of the substrate 40.

The transparent layer 48 is a piece of transparent glass arranged on the flange 64 of the frame layer 42 to cover the photosensitive chip 44.

The method for forming the image sensor will be described with reference to FIGS. 3 and 4. As shown in FIG. 3, a plurality of metal sheets 50 arranged in a matrix is provided. Each metal sheet 50 includes a first board 56, a second board 58 and a third board 60 formed by way of pressing. The middle board 52 is arranged between two opposite metal sheets 50.

As shown in FIG. 4, the injected material is provided to surround and seal each metal sheet 50 and the middle board 52 to form the substrate 40 and the frame layer 42 by way of injection molding. In this state, the first boards 56 of the metal sheets 50 are exposed from the upper surface 54 of the substrate 40 to form signal input terminals, and the second boards 58 are exposed from the lower surface of the substrate 40 to form signal output terminals. Meanwhile, the projections 68, which has the same height and protrude from the upper surface 54 of the substrate 40, are formed at the through holes 53 of the middle board 52.

Since the projections 68 are form by way of injection molding, the heights thereof may be easily and precisely controlled. Consequently, the photosensitive chip 44 may be flatly placed on the projections 68 of the substrate 40 even if the upper surface 54 of the substrate 40 is not flat enough. Therefore, the photosensitive chip may have better sensor effects.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

What is claimed is:

1. An image sensor, comprising:
a substrate having an upper surface and a lower surface, a plurality of signal input terminals being formed at a periphery of the upper surface, and a plurality of projections located at the same height being formed at a central portion of the upper surface;
a frame layer arranged on the periphery of the substrate to form a U-shaped structure and a cavity together with the substrate, wherein the signal input terminals and projections of the substrate are formed inside the cavity;
a photosensitive chip having a plurality of bonding pads and arranged on the projections;
a plurality of wires for electrically connecting the bonding pads of the photosensitive chip to the signal input terminals of the substrate; and
a transparent layer arranged on the frame layer to cover the photosensitive chip.

2. The image sensor according to claim 1, wherein the substrate includes a plurality of metal sheets arranged in a matrix and a middle board, the middle board is formed with a plurality of through holes, the metal sheets and the middle board are surrounded and sealed by an injected material by way of injection molding with the metal sheets exposed from the injected material to form a plurality of signal input terminals and a plurality of signal output terminals, and the injected material protrudes from the through holes of the middle board to form projections.

3. The image sensor according to claim 2, wherein each of the metal sheets includes a first board, a second board and a third board, the first boards are exposed from a top portion of the injected material to form the signal input terminals, the second boards are exposed from a bottom portion of the injected material to form the signal output terminals.

4. The image sensor according to claim 1, wherein the substrate and the frame layer are formed by way of injection molding.

5. The image sensor according to claim 1, wherein a flange is formed at an upper end of the frame layer and the transparent layer is arranged on the flange.

6. The image sensor according to claim 1, wherein the transparent layer is a piece of transparent glass.

7. The image sensor according to claim 1, wherein signal output terminals are formed on the lower surface of the substrate.
